(19) United States
(12) Patent Application Publication
(10) Pub. No.: US 2013/0211557 A1
(43) Pub. Date: Aug. 15, 2013

(54) SYSTEM AND METHOD FOR ON-LOCATION RESOURCE CONSUMPTION MONITORING AND MANAGEMENT

(71) Applicant: Gerald Michael O'Brien, Orleans (CA)

(72) Inventor: Gerald Michael O'Brien, Orleans (CA)

(21) Appl. No.: 13/806,658

(22) PCT Filed: Jul. 26, 2011
(86) PCT No.: PCT/CA2011/000865

§ 371 Date: Feb. 27, 2013

Related U.S. Application Data
(60) Provisional application No. 61/367,666, filed on Jul. 26, 2010.

(51) Int. Cl. G05B 21/02

(52) U.S. Cl. CPC G05B 21/02
USPC 700/73

(57) ABSTRACT

A system and method for on-location resource consumption monitoring and management including: a sensor attachable to a resource consumption meter monitoring raw resource consumption data outputted by the meter; an on-location network receiving the raw consumption data; a controller interfacing the network for processing the raw consumption data into processed consumption data; and a device linked to the network for displaying the processed consumption data to a user. The network may be linked to a remote server for uploading the processed data, further processing the data, and/or incorporating the data with third party analytical and reporting tools for resource consumption monitoring and management. The system and method may be used for monitoring and managing the resource consumption data of appliances and electronic devices through the use of control modules connected between an electrical supply and an appliance/electronic device.

### FIELD OF THE INVENTION

The present invention relates generally to resource consumption monitoring and management, and relates more specifically to a system and method for on-location monitoring and managing of resource consumption.

### BACKGROUND OF THE INVENTION

In the face of rapidly rising energy costs, consumers are demanding the ability to monitor and manage their energy consumption with a view to promoting energy efficiency and reducing consumption. To meet this demand, cost-effective, easy to use, accurate resource monitoring and management solutions are becoming increasingly popular to consumers.

Several inventions have been developed to try to address the need for monitoring energy consumption in particular. U.S. Patent Application Publication No. 2002/0072868, filed Jul. 13, 2001, is an example of one such invention. This application discloses a system and method for real time monitoring and control of energy consumption at multiple facilities and is directed towards aggregated control over power consumption. In this invention a central location receives information over a communications network from nodes placed at the facilities. The nodes communicate with devices within the facility that monitor power consumption. Load balance of a power grid may be achieved through activation or deactivation of electrical devices by the central location.

Another example of an invention directed to promoting energy efficiency and a reduction of consumption is to utilize a device to measure power consumption of an individual power consumer. Such an invention is disclosed in U.S. Patent Application Publication No. 2010/0235120, filed May 24, 2010 based on PCT/NL2008/050033 filed Jan. 18, 2008. This application discloses a device and system for measuring the power consumption of individual power consumers in an office and the like. A device is coupled to the respective consumer, and the device sends the signal originating from the respective consumer with the aid of ZigBee technology to a central receiver for processing. The central processing unit can be configured to provide information about the respective consumption to the consumer of the system and can also display a comparison with the desired consumption.

### SUMMARY OF THE INVENTION

In one aspect, the present disclosure relates to a system of on-location resource consumption monitoring and management, characterized in that it comprises: a sensor for receiving raw consumption data outputted by a resource meter; a controller for receiving the raw consumption data and processing the raw consumption data into processed consumption data; and a device linked to the network for receiving the processed consumption data and communicating the processed consumption data to at least one of the following: one or more resource consumption monitoring and management services; and one or more users.

In another aspect, the present disclosure relates to a computer-implemented method of on location resource consumption monitoring and management, characterized in that the method comprises the following steps: a sensor attached to at least one resource meter collecting raw consumption data from the at least one resource meter; transmitting the raw consumption data locally from the at least one resource meter to a controller; the controller processing the raw consumption data and generating processed consumption data; and the controller transmitting the processed consumption data to one or more of the following: one or more Internet-based servers; and one or more devices.

In yet another aspect, the present disclosure relates to a computer program product for use with an electronic device to monitor and manage resource consumption, said computer program product being useable on an electronic device, characterized in that it comprises: computer readable program code loaded on, or downloadable to the electronic device, the program code being operable on the one or more electronic devices to: receive raw resource consumption data transmitted from at least one sensor attached to at least one resource meter; process the raw resource consumption data and generate processed consumption data; transmit the processed consumption data to one or more remote electronic devices, whereby the processed consumption data is displayed to one or more users; and wherein the processed consumption data is utilizable to monitor and manage resource consumption and to develop one or more resource consumption management strategies.

In one aspect, the present disclosure relates to a system and method for on-location resource consumption monitoring and management.

In another aspect, the present disclosure relates to a system and method that provides a sensor for attachment to a resource consumption meter, the sensor for monitoring raw resource consumption data outputted by the meter; an on-location network in communication with the sensor, the network for receiving the raw consumption data; a controller interfacing the network, the controller for processing the raw consumption data into real time or near real time processed consumption data; and a device linked to the network for receiving the processed consumption data and displaying the data to a user; wherein the network is optionally linked to a remote server for uploading the processed data for further processing and/or incorporation with third party analytical and reporting tools for resource consumption monitoring and management. The system and method may also be used for monitoring and managing the resource consumption data of appliances and other electronic devices through the use of control modules connected between an electrical supply and an appliance/electronic device.

In yet another aspect, the present disclosure relates to a system of on-location resource consumption monitoring and management comprising a sensor for receiving raw consumption data outputted by a resource meter, an on-location network in communication with the sensor for receiving the raw consumption data from the sensor, a controller interfacing the network for processing the raw consumption data into a set of processed consumption data, and a device linked to the network for receiving the processed consumption data and displaying the data to a user in real time.

In still another aspect, the present disclosure relates to a computer-implemented method of on-location resource consumption monitoring and management comprising the steps of generating raw consumption data from an at least one resource meter, transmitting the raw consumption data locally from the at least one resource meter to a processor, processing the raw consumption data in accordance with parameters set by a user and transmitting the processed data to a display in response to a request sent by the user.

In another aspect, the present disclosure relates to a system that connects to a wide variety of meters, is connectable to third party devices, configures consumption data automatically in real time or near real time for local monitoring and management, and provides surprising improvements in terms of consumer adoption. In effect, the system of the present invention enables adoption of resource consumption monitoring and management technology by many more consumers than would otherwise have access to same. This provides critical mass that provides support to revenue models based on consumer engagement, thus releasing funds for marketing, investment in providing additional support to enable consumers to further decrease their consumption, whether via additional third party devices, better tools made available through web platforms, or perhaps additional financial or other incentives for consumers. The system of the present invention for enabling on-location resource consumption monitoring and management is uniquely and unobviously designed to promote adoption by consumers, in essence by putting consumers in control of the solution. In addition, based on the flexibility of this system, which enables special configurations based on-location requirements (e.g. different third party devices, different regulatory requirements, etc.), the solution can be flexibly adjusted for local requirements, thus enabling broad geographic adoption, and within specific markets where a variation of the solution is deployed, significant adoption within that specific market.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood and objects of the invention will become apparent when consideration is given to the following detailed description thereof. Such description makes reference to the annexed drawings wherein:

FIG. 1 is an exemplary system diagram illustrating structure of a system of resource consumption monitoring and management in accordance with one embodiment of the present invention.

FIG. 2 is a schematic view of an illustrative display module in accordance with one embodiment of the present invention.

FIG. 3 is a perspective view of an illustrative display module in accordance with one embodiment of the present invention.

FIG. 4 is a flow chart depicting a normal host/receiver module communications transaction in accordance with one embodiment of the present invention.

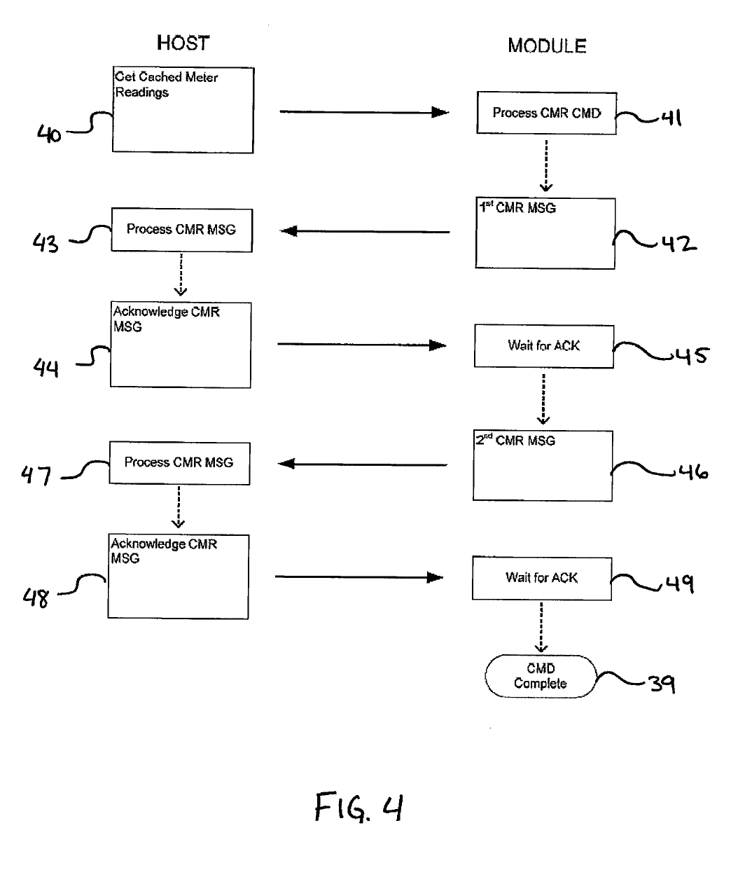

FIG. 5 is a system diagram illustrating the path of communication between a controller and multiple services in accordance with one embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF PREFERRED EMBODIMENTS

The system of the present invention represents a collection of hardware and software elements that enable a user to monitor and manage his or her resource consumption in an automated manner. The information collected by the various components of the system can be used within the system to implement an energy optimization regime for the user. Alternatively, the information collected can be transmitted to external systems for display and/or further processing. The present invention is a resource consumption monitoring and management system wherein consumers are able to precisely target the particular modalities of their energy usage in real time or near real time on-location.

It is understood that, generally, in order to influence consumer behaviour and to convince consumers to decrease energy use, consumers need to be provided with sufficient, readily accessible data pertaining to their consumption habits. This data is critical to facilitate consumption management by consumers. In particular, the data must accurately reflect actual consumption and associated price parameters in real time or near real time, with little effort required by consumers. The present invention represents a solution that may at least: (i) enable consumers to identify their consumption behaviors, using highly granulated, configured consumption data obtained from particular resource consuming devices and activities; and (ii) dynamically alter the consuming behaviour of one or more consumers, for example, by experimenting with different consumption reduction strategies.

The present invention may have a variety of embodiments. In one embodiment the present invention may include a system and method for on-location resource consumption monitoring and management.

In another embodiment of the present invention, the system and method may include a sensor that is attachable to a resource consumption meter. The sensor may be operable to monitor raw resource consumption data outputted by the meter. The present invention may further include an on-location network that is operable to communicate with the sensor in a bi-directional manner, whereby communications may be directed to and from the sensor, as well as to and from the network, between the sensor and the network. The network may be operable to receive the raw consumption data. A controller may interface the network, and said controller may be operable to processing the raw consumption data into real time or near real time processed consumption data. One or more devices may be linked to the network, and such devices may be operable to receive the processed consumption data and to display said processed consumption data to a user, who may be a consumer.

The network may optionally be linked to a remote server operable to upload the processed data for further processing for resources consumption monitoring and management. The remote server may also be operable to incorporate the processed data with third party analytical and reporting tools for resource consumption monitoring and management.

In one embodiment of the present invention, the system and method of the present invention may be used for monitoring and managing the resource consumption data of appliances and other electronic devices. Such an embodiment may include one or more control modules that are connected between an electrical supply and one or more appliances and/or electronic devices. The control modules may be operable to monitor and manage the resource consumption data of the appliances and/or electronic devices. In particular, the control modules may receive data from, and transmit data to, the appliances and/or electronic devices.

In another embodiment of the present invention, a system of on-location resource consumption monitoring and management may comprise a sensor for receiving raw consumption data outputted by a resource meter. The sensor may be in communication with an on-location network operable to receiving raw consumption data collected by the sensor and transmitted from the sensor to the network. A controller interfacing the network may also be included in said system. The controller may be operable to process the raw consumption data into a set of processed consumption data. A device may be linked to the network for receiving the processed consumption data and displaying the data to a user in real time.

Yet another embodiment of the present invention may include a computer-implemented method of on-location resource consumption monitoring and management. The method may comprise a variety of steps that involve a plurality of elements. As an example, the method may include at least the following steps: (i) a user setting parameters for processing of raw consumption data; (ii) generating and collecting raw consumption data from an at least one resource meter; (iii) the at least one resource meter locally transmitting the raw consumption data to a processor; (iv) the processor processing the raw consumption data in accordance with the parameters set by the user; and (v) the processor transmitting the processed data to a display means in response to a request sent by the user.

The present invention may be connectable or otherwise linkable or attachable to a variety of types of energy meters. The present invention may further be connectable or otherwise linkable to third party devices. The present invention may be configured in a variety of manners to achieve certain functions for local monitoring and management, for example, such as to provide consumption data automatically, to provide consumption data in real time, or to provide consumption data in near real time.

The present invention particular provides a view of resource consumption that may be configured to be as complete as possible. This is a desirable benefit of the present invention over the prior art, because more complete data improves the ability of the consumer to identify consumption reduction strategies, and for such strategies to cover and integrate a larger part of total consumption. This in turn may facilitate more effective resource savings strategies than is possible with the prior art.

It is known that consumer adoption of resource consumption monitoring and management solutions is often hindered by prior art solutions that require substantial work from the consumer and are known to only be directed at a partial view of overall energy consumption. The present invention offers a benefit and advantage over such prior art. The present invention is designed so that it does not necessarily require substantial work from the consumer. Therefore, users of the present invention may be more motivated to use the present invention than they are to use more laborious prior art system. The motivation to utilize the present invention may ultimately lead to a change of consumption habits by consumers. This change in behaviour and habits occurs because the present invention provides users with tools that are designed to provided, and directed at providing, a complete view of overall consumer energy consumption.

The present invention offers yet another benefit and advantage over the prior art in that it is an on-location system. Known prior art is generally a remote system, so that processing of the consumption data prior to enabling use of the data for management purposes occurs remotely from the consumer. The present invention provides on-location processing of the consumption data prior to enabling use of the data for management purposes. This improves the accessibility, utility, and speed of provision of such data to a consumer and therefore also improves the rate and scope of the development of energy management strategies by one or more consumers.

Generally, the system of the present invention may provide many consumers with access to a resource consumption monitoring and management technology that would not otherwise have such access. Therefore, the present invention provides a means for many consumers to adopt resource consumption monitoring and management technology. A related benefit of the present invention is that adoption of resource consumption monitoring and management technology by many consumers may provide a critical mass of adoption to the technology that is necessary to generate additional related benefits. For example, if many consumers adopt resource consumption monitoring and management technology revenue models based on consumer adoption may be developed that include funds that may be generated to be directed to marketing and investment in providing additional support to: (i) enable consumers to further decrease their consumption, whether via additional third party devices; (ii) develop better tools that may be made available through web platforms; or, perhaps, (iii) generate additional financial or other incentives for consumers based on decreased resource consumption.

Yet another benefit and advantage of the present invention is that its system for providing on-location resource consumption monitoring and management is uniquely designed to promote adoption by consumers, and is focused upon putting consumers in control of the solution for reducing resource consumption. Prior art systems do not provide a user with the same level of control over achieving such a solution.

Additionally, the present invention includes a flexible system that may permit special configurations based on location specific requirements (e.g. different third party devices, different regulatory requirements, etc.). Thus, the present invention may be flexibly adjusted for local requirements. This flexibility may facilitate broad geographic adoption, and adoption within specific markets where a variation of the system is required in order for a resource monitoring and management system to be deployed. Prior art systems do not offer the same level of flexibility as is provided by the present invention and therefore do not have the same potential for wide adoption as the present invention.

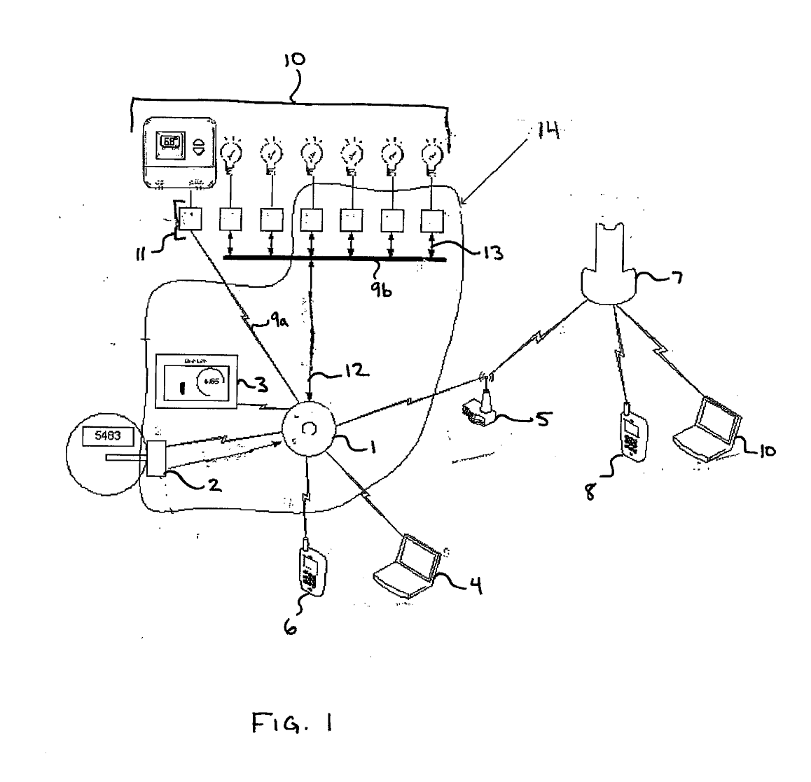

In one embodiment of the present invention, a system of resource consumption monitoring and management is provided, as shown in FIG. 1. This embodiment may include one or more of the elements shown in FIG. 1, as described herein. The system shall generally include an output source 2, and a controller 1 for interfacing to a computer network. The controller may be operable to collect and process resource consumption data received from the output source. The output source may consist of a sensor unit or other detection unit of the prior art variety. The sensor unit may preferably be a sensor unit of the type described in U.S. Pat. No. 7,174,260.

The sensor unit may passively attach to a resource consumption meter, for example, such as an electricity meter or any other resource consumption meter. The sensor unit may monitor the indication of power consumption output or otherwise provided by the meter. The sensor unit may: (i) be designed for self installation; (ii) require no fixed connection to an electrical source (i.e. it may not require hard wiring to an electrical source); and (iii) be compatible with a variety of analog and digital meters, for example, such as meters of the electromechanical type and electronic meters having optical ports.

The system of the present invention may be compatible with other sensor units, for example, such as sensors that are adapted for use with power meters that cannot be optically read, sensors that are electrically connected to a meter, and other sensors.

The sensor may be generally operable to communicate raw resource consumption data, or input data, to the controller 1. The controller may process the raw consumption data in real time, or near real time, into a set of processed data, for example, such as user-friendly processed data.

The processed data may consist of a variety of formats. In one embodiment of the present invention, the processed data may be time-stamped records. As an example, said time-stamped records may include data pertaining to any of the following: instantaneous demand and consumed power in energy units (i.e., watts/watt-hours, etc.); current energy prices; ambient outside temperature; sensor health; signal quality; and any other data. The processed data may be transmitted for presentation to a user on a display unit 3, for example, such as an in-home display unit, or any other display unit or means.

The controller 1 may be adapted to communicate with a plurality of control modules 11 having an electrical connection between a home's electrical supply 9a, 9b and any appliance or device connected to the electrical supply 10. The electrical supply communication path 12 between the controller and one or more control modules 11 may be bi-directional. The present invention may be configured to allow for this communication with control modes either instead of, or as well, as communication with a sensor unit. As an example, of this communication operation, the controller may communication with household appliances 10 connected to the electrical supply, and/or any household device that consumes electricity (e.g.: lights, motors, heaters, stove, refrigerator, radio, television, etc.) and is connected to the electrical supply. The electrical supply wiring or other connection 13 within the location may be used as a communications channel between the controller and any control module 11, for example, such as by using power-line-carrier (PLC) technology and protocols, a wireless communication means (e.g., such as a WiFi connection), or any other means.

The system may have a recognized boundary 14, enclosing specific elements that are internal to the system. This boundary may include all or only some of the elements that are accessible by the system. For example, not all of the control modules, appliances, devices accessible by the controller may be included within the boundary. The boundary may be applied to limit the elements included in the collected and processed data, and this may further allow for specific resource monitoring and management results and/or strategies of decreasing resource consumption. In embodiments of the present invention the boundary may be set and may be altered by a user of the system.

The controller may process the raw consumption data to produce processed consumption data related to the consumption of a specific user. The processed data may be transmitted to a variety of remote storage areas, servers, devices or transmission means. The transmission of the processed data may be for a variety of purposes, for example, such as to provide consumption details to a user, to provide the data to be compiled with, or otherwise utilized with, data from one or more other users, to be further processed by an external processor, or for any other reasons.

In one embodiment of the present invention the controller may transmit processed data to a remote server or device. For example, data may be transferred via a WiFi connection. In such an embodiment, a WiFi gateway 5 may be used to communicate processed data. As an example, the data may be transmitted through the WiFi gateway to a remote monitoring and/or management service 7, or to another receiving party, over the Internet.

If the data is transmitted to one or more remote monitoring and/or management service, such services may be of various types, for example, such as one or more internet-based third party servers.

The WiFi gateway may also be used to communicate data from other devices such as for example a WiFi enabled smart plug, or for communication to the remote monitoring and/or management service.

The data, a portion of the data, or data processed by a remote monitoring and/or management service, may be delivered to an electronic device belonging to a user, or to another party. For example, the data may be transferred from an Internet based server 7 to a handheld electronic device 8 or a laptop 10, as shown in FIG. 1. The data that is transferred in this scenario may be the data as processed by the controller, or may be data that is further processed by a remote monitoring and/or management service. A skilled reader will recognize that the system may be configured in a variety of ways to provide the whole of data, or a portion of data, at some level of processing, to a remote device or remote service.

The present invention may also be operable to transmit data via a public communications channel. The public communications channel may be, for example, a communications channel such as a cellular communications channel, or any other public communications channel. As shown in FIG. 1, the controller 1, may transfer the whole of processed data, or a portion of processed data through a public communications channel to an electronic device, for example, such as a handheld device 6 (e.g., a cellular phone, a smart phone, etc.) or a computer 4 (e.g., a laptop, a desktop, a tablet, etc.).

The control modules may individually communicate raw resource consumption data to, and receive processed consumption data from, the controller. The controller may process the consumption data into processed data that defines specific details relating to the appliance or device connected to the control module, or to define specific operations to be undertaken by the control module. For example, the controller may process the consumption data to determine specific details relating to an appliance connected to the control module, such as any of the following: the type of appliance attached to each control module; whether the appliance is to be controlled or simply monitored by the control module; the priority of the appliance (non-essential to essential); the category of the appliance (e.g. light, heater, etc.); the zoning of the appliance (e.g. the room where the appliance is located); and any other details of the appliance. The controller may also process consumption data to determine specific details relating to devices connected to a control module as well. The consumption data may be fed back to the controller using various communications mechanisms, including wireless and power line (e.g. through existing household wiring).

Each control module may have the ability to control the appliance or device attached to it either through commands received from the controller, or based on internal algorithms or other calculations. For example, if other appliances in the room are off and the lights have been on for more than 10 minutes then the control module may operate to turn the lights off. As another example, if all the appliances in the room are off and the lights are turned on, then the control module may be operable to automatically turn on other appliances. The latter example could be used as a convenience mechanism to minimize the impact (or visibility) of an energy conservation regime on the home owner.

As still another example, an internal algorithm or other calculation could be applied that takes into account the level of energy consumption and current energy price. This algorithm may be utilized to reduce consumption (by turning off or on) an appliance or device in accordance with the level of resource consumption and/or the cost of the resource (energy) consumed during a period of time, so that resource consumption does not exceed past a certain level and/or the resource consumption does not exceed a particular total price. This algorithm may be particularly advantageous to keep energy costs in check when energy costs spike or even rise in a more slight manner at various times during the day. This aspect of the invention could be applied to encourage (or force) the consumer to run an appliance or device, for example, such as the dishwasher, at a time when consumption levels have not accumulated to a high level, or when the energy cost is lower, such as overnight when energy rates are generally at the lowest price.

The controller may further, or alternatively, utilize the raw resource consumption data to learn user behavior patterns. For example, the controller may process the data to determine behaviour patterns such as: entry and/or exit from the location (such as a home or office) by the user; high-demand times, such as breakfast and/or dinner times; and/or commonly used rooms, commonly used appliances or commonly used devices. The controller may utilize such information that indicates user behavior patterns within the location to adapt resource consumption within the space. For example, the controller may network with appliances or devices, or control appliances and devices, to minimize resource consumption.

Control of appliances or devices by the controller may be based on factors such as the amount of resources consumed by the appliance or device, the priority of the appliance or device, the grouping of the appliance device (for example a lamp near a stove may be grouped together and may need to both function simultaneously to allow a user to prepare and cook a meal), or other aspects of an appliance or device. For example, if some of the appliances are baseboard heater thermostats and the system has learned that the location is typically not occupied from 9 am to 5 pm, then at 9 am the controller may turn down all the baseboard heaters to reduce electricity consumption while the location is not occupied. The controller may later turn the baseboard heaters back up at 4 pm when the location will be occupied (or shortly before 4 pm so that the location will have warmed up before the user returns to the location). The controller may monitor the rate of change of temperature in each zone and on subsequent days begin the temperature restoration cycle earlier or later to obtain the desired temperature at the correct time.

The controller may also be configured to accept user input to further maximize energy savings. The controller may be configured to accept user input at any time, or only after the controller has collected a sufficient amount of raw energy data to process user behavior patterns. The user input may be in a variety of forms, for example, such as in the form of a percentage of existing usage. For example, the user may specify that they wish to reduce electricity consumption by a further 10%. The controller may begin to control appliances more aggressively based on the priority of the appliances and the zones in which they are located in order to achieve the conservation goal. For example, more essential appliances located in zones that are less utilized could be controlled to reduce consumption. The controller may monitor the activity in all zones. When an inactive zone becomes active (e.g.: user enters the zone and turns on a light) the controller may restore power to all appliances that it had previously turned off in order to minimize user inconvenience.

Utilizing cost of consumption parameters, such as rates per kWh, the controller may process the consumption data to produce real-time, or near real time, consumption feedback for the user. The cost of consumption parameters may include cost of electricity in a tiered manner and a schedule that can be structured based on volume of electricity consumed, the time-of-day the electricity is consumed, or both. The processed data may be transmitted to a display module 3 and/or other electronic devices in communication with the controller, as shown in FIG. 1. For example, such electronic devices may include a variety of devices, such as one or more handheld devices 6, one or more personal computers 4, or any other electronic device in communication with the controller and thereby within the network. Moreover, the processed data may be transferred through a remote device, such as a WiFi gateway, to an internet server, and then transferred onto other remote devices, as described herein. A skilled reader will recognize the variety of configurations of the present invention whereby processed data, or even subsequently processed data, may be transmitted to one or more users or remote resource consumption monitoring and/or management services.

In one embodiment of the present invention, the processed data may be transmitted to an external system and/or external devices via routing through a remote server 7. For example, the external devices may include any type of external device, such as one or more handheld devices 8 (e.g. a cellular phone, a smart phone, or any other handheld device), a personal computer 10 (e.g. a laptop, a desktop computer, a tablet, or any other personal computer), or any other external device. In this embodiment of the present invention, the processed data may be utilized by third parties. For example, such use by third parties may include uses, such as additional processing, use with other analytical and reporting tools for resource consumption monitoring and/or management, or other uses by third parties.

In one embodiment of the present invention, a display module 3 may be included in the system. Said display module may have a screen, for example, such as a LCD screen, or any other screen. The display module may be a battery operated portable monitor. Generally, the display module may be configured to interoperate with, and receive transmissions from, the controller. An input means may be associated with, or otherwise linked to, the display means, whereby a user may be able to transmit specific information to the controller, such as cost of consumption parameters and/or resource pricing information, for the purpose of manipulating the processing step or otherwise determining activities of the controller. For example, the user may utilize the input means to indicate to the controller a percentage of resource consumption increase or decrease to be applied by the controller, as described here. A skilled reader will recognize the variety of information that may be input to the system through an input means by a user.

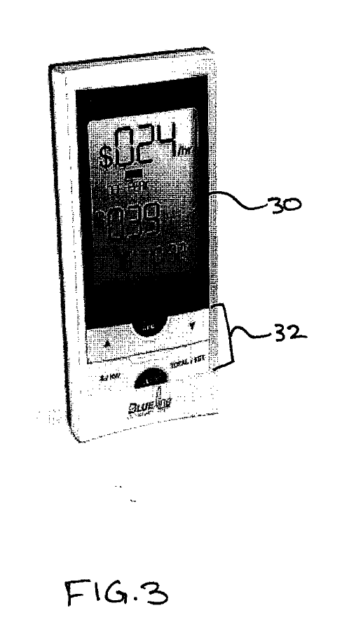

The input means may be of a variety of types. For example, such as a touch screen, a keyboard, or any other input means. As shown in FIG. 3, the input means may include buttons 32 that may be operable for a variety of purposes, including the options of increasing or decreasing generally, and buttons to display specific information, such as the price of energy, or any other buttons.

Users receiving processed data on a remote electronic device in communication, directly or indirectly, with the controller, for example, such as a hand held device or a personal computer communicating with the controller through means described herein, may also provide input to the controller in some embodiments of the present invention. The input may be inputted through the input means associated with the electronic device (e.g., touch screen, keyboard, buttons, or other means), and the data and/or input may be displayed on the display means integrated in the electronic device. The type of input provided by a user through a remote electronic device may be the same or similar to the input that a user may input into an input means connected to the display module.

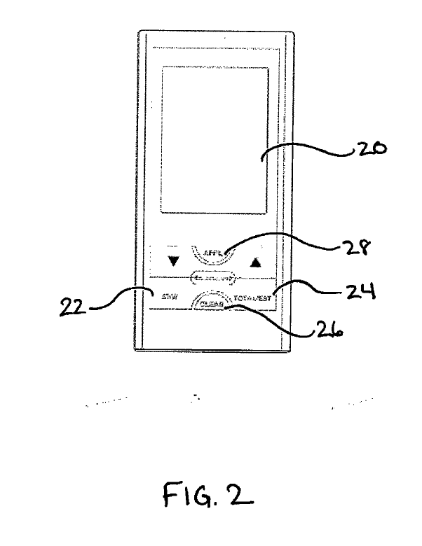

A skilled reader will recognize that the display module may be of a variety of types and formats. As an example, embodiments of the display module may be those shown in FIGS. 2 and 3. The display module may include a screen 20, as shown in FIG. 2. The screen may display a variety of information received from the controller as processed data. For example, the screen 30 may display multiple pieces of information derived from the processed data sent from the controller to the display module, as shown in FIG. 3.

In one embodiment of the present invention, the controller may transmit the processed data to the display module, which displays real time energy consumption to the user, for example, in dollars and cents and/or kWh. A user may utilize the display module to set the billing mode and billing rate used by the utility company for the user's location. Billing rates tend to be either: (i) time-based rates, wherein the user is charged, for example, normal (OFF PEAK) and peak (ON PEAK) rates or on a three-rate basis, where an intermediate rate (MID PEAK) is added; (ii) single (flat) rates; or (iii) tiered rates, wherein rates are set on a sliding scale in accordance with certain pre-defined consumption thresholds; or hybrids of the foregoing. Using the appropriate billing rate model, the user may then proceed to configure the system using his or her latest utility bill, by inputting the billing model and the specific billing rates per kWh.

Optionally, the system could include a mechanism wherein a user inputs his or her name and location data, such as home address and/or zip code, and a server is operable to provide pricing information directly to the user and/or display module. Further, or in the alternative, the system could be adapted to connect to a utility company server for the purpose of obtaining information regarding changes to pricing information, etc., and updating the display module with those changes. Further, the display module could be utilized for conveying special offers from the utility or utility partners, updating artwork on the display screen, and/or sending congratulatory graphic material if reduction goals are achieved, etc.

In one embodiment of the present invention, the display module and/or controller may be configured to communicate with permitted remote devices, such as remote computers, and block out ones that are not permitted in order to receive such data.

The system generally, or elements of the system (e.g., such as the display mode, controller or other elements of the system), may serve to read moment-to-moment resource use and costs, measure how much energy is being consumed by specific appliances, predict future energy use and costs based on current usage and/or past usage trends, and track cumulative information. In this regard, the basic functions of the display module may include as follows: (i) Appliance function—zeroes out base consumption and measures how much energy and monetary costs are contributed by specific appliances and actions; (ii) Predictive function—based on current usage and/or past usage, estimates energy use and costs for some future period of time, for example, the next thirty (30) days; (iii) Sleep function—prevents battery run down should the module and sensor lose connectivity; (iv) Track cumulative information—allows the user to reset data as frequently as he or she wishes—hourly, daily, weekly, monthly, etc.; (v) Flexible programming to match local utility rate structure, for example, for matching flat rate, multi-tier (i.e. rates by usage), and/or on-off peak (i.e. time of use rates) structures; and (vi) displays time and outside temperature of the power meter.

In one embodiment, shown in FIG. 2, the display module is fitted with the following primary buttons: a $/kW button 22—operable to toggle the display of values between dollar and kilowatt amounts; a TOTAL/EST button 24—operable to toggle the display of values between current consumption and estimated 30-day consumption; a CLEAR button 26—for resetting the consumption totals to zero; and a APPL button 28—for toggling the APPL function on and off, wherein the APPL function allows the user to measure the amount of power consumed by a single appliance.

Optionally, the bottom row of the display screen 30, as shown in FIG. 3, displays the current day of the week, as well as the temperature and time in the formats selected by the user when configuring the module, while the consumption total values (Dollars and kW) appear on the middle row and the top row displays current energy consumption. If the user presses the $/kW button repeatedly, the display alternates between values in dollars per hour and kilowatts per hour in the top row. Regarding the consumption totals in the middle row of the display, pressing the TOTAL/EST key alternates the displayed values on this row between the current total consumption (the TOTAL indicator is displayed) and a calculated estimated consumption for 30 days (the EST indicator is displayed). Further, when measuring a single appliance using the display module, the user may press APPL, the module memorizes the total current consumption and then displays only the consumption above that value until the APPL button is pressed again.

In one embodiment of the present invention, the functionality of the display module may be repeated or independently adopted in a software application for use with an electronic device, such as a computer or wireless handheld device, wherein the electronic device is in communication with the on-location network. For example, a client application could also be implemented on a local computer of the user, and linked to the network of the present invention for providing this functionality. The local computer could be a personal computer or for example a wireless handheld such as an iPhone™, ANDROID™ device or BlackBerry™.

Similarly, in one embodiment of the present invention, the display module may be equipped with Wi-Fi™ and/or Bluetooth™ or other similar wireless support, for linking the display module to the Internet and/or connecting the display module to other electronic devices, such as smartphones, in-car communications systems, and the like. Of course, the controller itself could be similarly so equipped. In these iterations, the user consumption data and/or aspects thereof, such as daily/weekly/monthly rates of consumption, consumption per appliance, changes in consumption over time, etc. could be posted to social networking sites such as Facebook™ or Twitter™, or some other site for the purpose of engaging with the web community and creating a dialogue, wherein consumers could share current and historical consumption data, trends and observations, answer each other's questions, post energy saving tips, create online contests with a view to meeting consumption reduction targets, etc.

As mentioned, the controller may be adapted to transmit the processed data remotely to an external network, for example, such as for the purpose of web presentment of the data for use with a third party home energy monitoring and/or management service, such as Microsoft Hohm™ or Google Power Meter™, any other third party home energy monitoring and/or management service, or to any other purpose. Generally, external web platforms analyze user generated resource consumption data, produce and display associated reports, and generate specific suggestions for reducing consumption, based on then current best practices implemented to the web platform. These external web platforms generally rely on granular consumption data in order to achieve full functionality of the platform's applications for a user. Microsoft Hohm™ is an online system that enables consumers to analyze their energy usage and obtain energy saving recommendations. Similarly, Google PowerMeter™ enables users to access their personal home energy data and help them to understand their energy usage habits. As stand-alone systems, these prior art web platforms have been criticized as being dependent on use of a smart meter by the user. Currently, broadcasting smart meters represent just 4% of all deployed meters. In contrast, the system of the present invention, which includes sensors for retrofitting on meters, works with the majority of meters in use today, including broadcast and non-broadcast smart meters. For example, the system of the present invention may work with approximately 90% of the meters in use today.

In addition, while these web platforms are supported by a handful of participating utility companies, such that these utilities are able to transmit a given user's consumption data directly to the third party service, where a user's home is not supported by one of these utilities, then the user will not have real time or near real time access to his or her consumption data. In any event, utilities, at best, collect usage information from the smart meters installed on their customers' homes in 15 minute intervals. More commonly it is collected hourly or daily. Of course, the collection interval governs how precisely consumption can be targeted. In contrast, the system of the present invention is able to read (collect) consumption data at shorter intervals, for example, such as around approximately every 25 milliseconds, and report (transmit) consumption data in shorter intervals, for example, such as around approximately 32 second intervals.

Moreover, while utilities may gather the data at 15 minute intervals, it is typically captured into a meter management system in a form that needs to be processed further prior to being usable by other systems. That processing frequency is typically once every 24 hours. Of course, this 24 hour time-lag confines these web platforms to displaying day-old consumption data to their users and limits their usefulness as a control system. With the system of the present invention, the consumption data is processed as soon as it is received from the sensor, or control module, in other words, every approximately 32 seconds, and is ready to be uploaded to other systems. It is also important to note that the utilities are generally implementing systems that enable them to calculate pricing information, which depends on consumption and energy costs (which can fluctuate a lot depending on the jurisdiction), and is mainly used for billing purposes. Today, utilities are not particularly motivated to enable the consumer to access this consumption data as this would place burden on their system infrastructure, and possibly require additional licensing fees to their technology providers.

In one embodiment of the present invention, the system may include a analytical and web presentment service, which may be local or remote to the system, with the web service leveraging a series of web tools that enable the richer data presented by its system to be translated in more effective solutions for reducing resource consumption. In addition, the service provided in association with the present invention may have the ability to act as a resource data collection point with “connectors” that enable the collected data to be disseminated to third party services. In essence the service may act as a clearing house for energy consumption data. Such a mechanism may enable a homeowner to subscribe to multiple third party energy presentment/management services and have their consumption data automatically sent to such third party services.

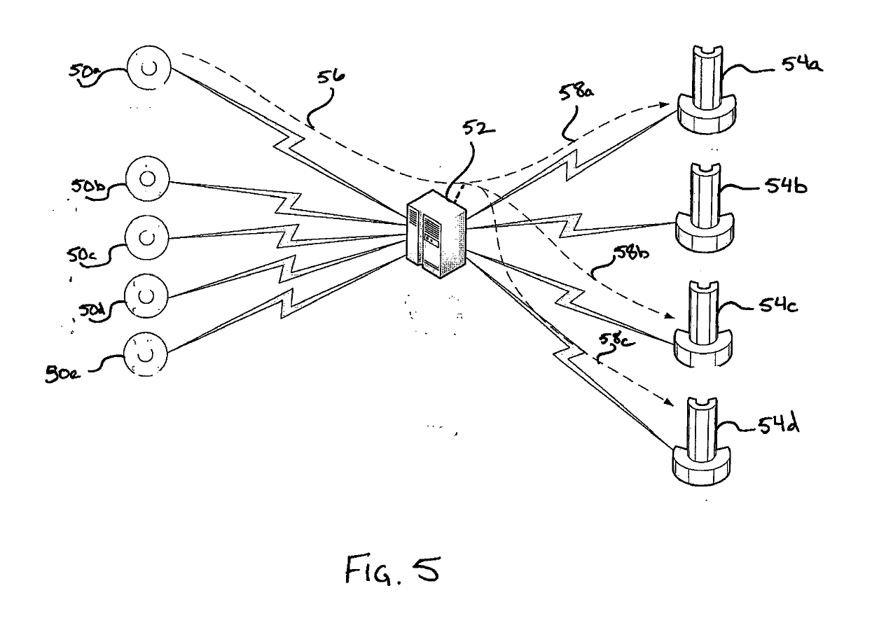

As shown in FIG. 5, processed energy consumption data relating to one or more users may be generated by the controller for the one or more users 50a, 50b, 50c, 50d, 50e. The present invention may function so that the controller for a particular user 50a may transmit processed energy consumption data to a collection system 52. For example, the controller transmission path 56 exemplifies the transfer of energy consumption data to the collection system.

Also, a number of service providers may offer services that may be utilized with the present invention, 54a, 54b, 54c, 54d. A skilled reader will recognize that a user of the present invention may subscribe to one or more of a variety of service providers. For example, as shown in FIG. 5, the user may have subscribed to services offered by one or more service providers 54a, 54c, 54d. The collection system 52 may automatically forward or otherwise transfer the energy consumption data for the user to the service provider systems of the subscribed services 54a, 54c, 54d. As an example, the energy consumption data may be forwarded or otherwise transferred from the collection system 52 to the service providers along multiple service provider transmission paths 58a, 58b, 58c.

Taken together, the system of the present invention provides more granular data, collected and made available for transmission frequently, for example, such as every approximately 32 seconds, all without the involvement of the utilities. By linking this system with an existing third party home energy monitoring and/or management service web platform, the platform becomes accessible to many users who might not otherwise have had access, and the functionality of the platform from the perspective of the user is greatly improved.

It should also be noted that the enhanced data, made available by operation of the present invention, may be provided to utilities for example in order to enable better understanding of their customers.

The system of the present invention optionally incorporates a receiver module as the controller for communicating with an at least one sensor unit for transmitting consumption data to the receiver module. The receiver module is capable of processing the consumption data in a variety of ways and transmitting the processed data to the display module or other local electronic devices, or optionally to some external electronic device or third party system, such as a web presentment tool or other web platform. The receiver module is particularly useful when utilized in conjunction with web presentment applications, as a means for enriching the consumption data available to the web application. The receiver module incorporates a set of user functions that are normally found in smart meters. For example, it enables users to build in aspects that are normally part of the back end system of the utility company who processes the meter data.

Consumption data inputs are received by the receiver module and data is exchanged between the receiver module and the applicable host system in communication with the module. In terms of the format of the data exchanged between the receiver module and the applicable host system, there are two types of messages: Host Interface and Application. The Host Interface message (HIM) is used in all transactions between the host and the receiver module and is essentially a container for application-level messages. The Host Interface message protocol defines transactions comprised on an exchange of “initiator” (INT) and “acknowledge” (ACK) messages. In one embodiment, if the transaction initiator does not receive an ACK message from the recipient within 500 ms, it will resend the INT message up to three (3) times, after which the transaction will be aborted if an ACK message is not received.

Application messages generated by the receiver module include, generally, “command” and “response”, wherein the format of each message is specific to the command involved. Command messages are initiated by the host in order to request information from the receiver module. Response messages are returned by the receiver module and contain the requested data. Application messages can include the following:
(i) a current period summary (CPS) message containing a summary of energy usage for the current billing period;
(ii) a previous period summary (PPS) message containing a summary of energy usage for the previous period;
(iv) a module status (STATUS) message providing information about the current operational status of the module and the paired sensor unit;
(v) a module configuration (CONFIG) message containing the information required to configure the module to correctly measure and calculate energy consumption;
(vi) a tier switch schedule (TSS) used to determine when a change should occur in the pricing used to calculate electricity usage;
(vii) a cached meter reading (CMR) derived from the readings received from the paired sensor unit at approximately 32 second intervals;
(viii) cached hourly data (CHD) calculated from the cached meter readings and calculated a the top of each hour;
(ix) a billing date (BD) message is used to set or get the last billing date;
(x) the sensor address (SA) is the address the module will use to determine which sensor unit it should accept messages from.

A host/receiver module communications transaction may generally include a set of steps. For example, such a host/receiver module communication transaction may involve a host requesting the last two (2) meter readings from the receiver module, as shown in FIG. 2. In this example scenario, the process may begin with the host initiating the transaction 40, such as with the GET CMR command. The module may respond within the required time with the first meter reading. for example, the module may process the CMR command 41 sent from the host, and may generate a first CMR message 42 that it transmits to the host. The host may process the CMR message 43 received from the module, and the host may acknowledge the CMR message 44. Note that the host may be required to acknowledge each message received by sending an ACK message within the time set for acknowledgement. The module may wait for the acknowledgement 45, and may send a second CMR message 46 to the host upon receipt of the acknowledgement from the host. The host may process the CMR message 47 and may acknowledge the CMR message 48. The module may wait for the acknowledgement 49 to be sent from the host. In this example, the transaction completes 39 when the receiver module transfers the last CMR message with the HIM sequence number set to 0.

It should be understood that the present disclosure discusses at length energy at a resource, the consumption of which is monitored and managed by operation of the present invention. It should be understood that the application of the present invention may be extended to other resources such as gas or water by application of the methods and technologies described to such gas or water related consumption measurement.

As previously indicated, the present invention provides flexibility in enabling the generation of “whole location” resource consumption data in part by interfacing with third party devices. For example programmable thermostats or smart appliances that enable real time data access, or smart plugs that provide the ability to integrate data from specific appliances. Various other devices are being introduced all the time that enable the consumer to better understand and control resource consumption associated with the location. The present invention enables great variety in the mix of specific devices to be used on-location, and the system described improves the overall management and control parameters of the on-location system, linked to such devices, for resource consumption monitoring and control.

This flexibility is also important by enabling the present system to be easily integrated with other system for improved control of energy consumption based on monitoring enabled by the present invention. For example, an intelligent thermostat can use the whole-home consumption information to adjust the temperature within a home, within limits, so as to avoid reaching a preset peak energy consumption level, or other appliances could use such information to delay the start of a high energy consuming cycle or to disable certain functions when overall consumption is high.

It should be understood that the present invention may be extended by linking the invention with other technologies or processes useful in the monitoring or management of resource consumption. For example, the web presentment service may be improved by leveraging advanced analytics, by applying state-of-the art time dependent data mining for identifying trends and using these trends to dynamically adjust resource saving strategies suggested to individual consumers based on their resource consumption parameters.

It will be appreciated by those skilled in the art that other variations of the embodiments described herein may also be practiced without departing from the scope of the invention. Other modifications are therefore possible.

I claim:

1. A system of on-location resource consumption monitoring and management, characterized in that it comprises:
(a) a sensor for receiving raw consumption data outputted by a resource meter;
(b) a controller for receiving the raw consumption data and processing the raw consumption data into processed consumption data; and
(c) a device linked to the network for receiving the processed consumption data and communicating the processed consumption data to at least one of the following: one or more resource consumption monitoring and management services; and one or more users.

2. A system of claim 1, characterized in that it comprises an on-location network in communication with the sensor, said on-location network being operable to receive the raw consumption data from the sensor, and the controller interfacing the on-location network.

3. The system of claim 1, characterized in that it comprises the controller being linked to a remote server for transmitting the processed consumption data to a third party via one or more of the following transmission means: public communications channel, or an Internet-based communications channel.

4. The system of claim 3, characterized in that it comprises the controller transmitting the processed consumption data through the Internet-based communications channel, via a remote router to a third party server, and the processed consumption data is transmitted from the third party server to one or more electronic devices.

5. The system of claim 1, characterized in that it comprises the one or more resource monitoring and management services being operable to incorporate the processed data with third party resource consumption data, and further being operable to apply analytical tools and reporting tools to the processed data for resource consumption monitoring and management.

6. The system of claim 1, characterized in that the controller is operable to collect consumption data at short intervals and to report the processed consumption data at short intervals.

7. The system of claim 1, characterized in that an on-location display module receives the processed consumption data and displays all or a portion of the processed consumption data to the user.

8. The system of claim 1, characterized in that the controller is operable to communicate with one or more control modules, said one or more control modules each being connected to one of a plurality of appliances or devices that is connected to the electrical supply.

9. The system of claim 8, characterized in that the controller is operable to cause the control modules to turn one or more of the plurality of appliances or devices on or off.

10. A computer-implemented method of on location resource consumption monitoring and management, characterized in that the method comprises the following steps:
(a) a sensor attached to at least one resource meter collecting raw consumption data from the at least one resource meter;
(b) transmitting the raw consumption data locally from the at least one resource meter to a controller;
(c) the controller processing the raw consumption data and generating processed consumption data; and
(d) the controller transmitting the processed consumption data to one or more of the following: one or more Internet-based servers; and one or more devices.

11. The method of claim 10, characterized in that it comprises the further steps of
(a) the user requesting the processed data;
(b) the controller receiving the user request and transmitting the processed data to a display module, whereby the processed data is displayed to the user.

12. The method of claim 10, characterized in that it comprises the further steps of:
(a) one or more control modules that are connected to one or more appliances or devices that are further connected to the electrical supply communicating raw resource consumption data relating to the one or more appliances or devices to the controller; and
(b) the controller processing the raw resource consumption data as the processed consumption data and defining one or more of the following:
(i) specific details relating to each of the one or more appliances or devices; and
(ii) defining an operation to be undertaken by one or more of the one or more control modules for resource management; and
(c) the controller transmitting the processed consumption data to the one or more control modules.

13. The method of claim 12, characterized in that it comprises the further steps of:
(a) transmitting the processed consumption data to one of the one or more control modules, said processed consumption data including the defined operation; and
(b) the one of the one or more control modules operating in accordance with the defined operation and thereby controlling the appliance or device connected to said control module by either: turning the appliance or device “on”; or turning the appliance or device “off”.

14. The method of claim 12, characterized in that it comprises of the further steps of the defining the operation in accordance with one or more of the following: the level of energy consumption of the appliances and devices; and the cost of the resource consumption by the appliances and devices.

15. The method of claim 12, characterized in that it comprises the further steps of:
(a) the controller monitoring the appliances and the devices connected to the control modules and the raw consumption data from the sensor to determine user behaviours patterns; and
(b) the controller minimizing resource consumption based on the user behaviour patterns.

16. The method of claim 10, characterized in that it comprises the further steps of:
(a) a user transmitting data to the controller; and
(b) the controller utilizing the data transmitted by the user to control resource consumption.

17. The method of claim 10, characterized in that it comprises the further step of a user receiving real time resource consumption information from a display module connected to the controller.

18. The method of claim 10, characterized in that it comprises the further step of the controller receiving raw consumption data that provides moment-to-moment data including one or more of the following: appliance function; predictive function; sleep function; cumulative information; flexible programming; temperature of the at least one resource meter.

19. A computer program product for use with an electronic device to monitor and manage resource consumption, said computer program product being useable on an electronic device, characterized in that it comprises:
(a) computer readable program code loaded on, or downloadable to the electronic device, the program code being operable on the one or more electronic devices to:
(i) receive raw resource consumption data transmitted from at least one sensor attached to at least one resource meter;
(ii) process the raw resource consumption data and generate processed consumption data;
(iii) transmit the processed consumption data to one or more remote electronic devices, whereby the processed consumption data is displayed to one or more users; and
wherein the processed consumption data is utilizable to monitor and manage resource consumption and to develop one or more resource consumption management strategies.

20. The computer program of claim 19, characterized in that it comprises the computer program product being operable to communicate with one or more remote monitoring and managing resource consumption services, and to transmit processed consumption data to said one or more remote monitoring and managing resource consumption services.
